(19) United States
(12) Patent Application Publication
(10) Pub. No.: US 2020/0055450 A1
(43) Pub. Date: Feb. 20, 2020

(54) ILLUMINATION DEVICE FOR INSIDE A VEHICLE AND METHOD FOR PRODUCING AN ILLUMINATION DEVICE

(71) Applicant: ADIENT ENGINEERING AND IP GMBH, Burscheid (DE)

(72) Inventors: Tomás DRBOHLAV, Liberec (CZ); Miroslav RÍHA, Strakonice (CZ); Jaroslav LÍR, Velim (CZ)

(21) Appl. No.: 16/346,751

(22) PCT Filed: Nov. 2, 2017
(86) PCT No.: PCT/EP2017/001272

§ 371 Date: May 1, 2019

(30) Foreign Application Priority Data
Nov. 2, 2016 (DE) 10 2016 013 017.2
Nov. 9, 2016 (DE) 10 2016 013 261.2

(51) Int. Cl. B60Q 3/68; B60Q 3/74

(52) U.S. Cl. CPC B60Q 3/68; B60Q 3/74

(57) ABSTRACT

An illumination device for inside a vehicle has a radiation source (2), which is a source for ultraviolet radiation. The illumination device also has at least one surface element (6) having fluorescent substances or phosphorescent substances. Visible light is emitted from the respective substances in response to an excitation by the ultraviolet radiation, such that the inside of the vehicle can be extensively illuminated, without dazzling the driver with bright light sources. A corresponding method is further provided for illuminating inside a vehicle, and to the use of an illumination device for this purpose.

### CROSS REFERENCE TO RELATED APPLICATIONS

This application is a United States National Phase Application of International Application PCT/EP2017/001272, filed Nov. 2, 2017, and claims the benefit of priority under 35 U.S.C. § 119 of German Applications 10 2016 013 017.2, filed Nov. 2, 2016 and 10 2016 013 261.2, filed Nov. 9, 2016, the entire contents of which are incorporated herein by reference.

### TECHNICAL FIELD

The invention relates to an illumination device for an interior of a vehicle, which illumination device has at least one radiation source, which can emit radiation, and at least one surface element from which, as a reaction to radiation that was emitted by the radiation source and arrives at the surface element, visible light emerges and to a method for producing an illumination device for the interior of a vehicle. The invention furthermore relates to a method for illuminating the interior of a vehicle.

### TECHNICAL BACKGROUND

Such an illumination device has at least one radiation source, which can emit radiation, and has at least one surface element from which, as a reaction to radiation that was emitted by the radiation source and arrives at the surface element, visible light emerges. Such illumination devices are known, wherein the radiation source in these known illumination devices is a commercial lamp which emits radiation in the form of visible light to illuminate the interior of the vehicle, in particular if the vehicle is standing. When the light strikes surfaces in the interior of the vehicle, these surfaces also output light, with the result that these surfaces are visible. The radiation sources in the form of light sources are, however, very bright in points and are therefore operated only when the vehicle is standing so as not to dazzle the driver while he or she is driving. During the journey, the interior of the vehicle therefore appears very dark, overall.

### SUMMARY

The invention is based on the object of illuminating a large area of the interior of a vehicle without dazzling the driver with bright light sources.

The invention achieves this object by way of an illumination device for the interior of a vehicle, wherein the illumination device has at least one radiation source, which can emit radiation, has at least one surface element from which, as a reaction to radiation that was emitted by the radiation source and arrives at the surface element, visible light emerges, provision is made in accordance with the invention for the radiation source to be a source for ultraviolet radiation and for the surface element to have fluorescent substances or phosphorescent substances or to have fluorescent substances and phosphorescent substances, wherein the visible light emerges from the respective substances as a reaction to an excitation by the ultraviolet radiation.

The ultraviolet radiation lies outside the visible range and therefore does not disturb the driver of the vehicle. The fluorescent substances, which are present in particular in the form of optical brighteners, are excited by the ultraviolet radiation and emit visible light as a reaction thereto. The phosphorescent substances are used to achieve continued illumination even after the radiation source for ultraviolet radiation is extinguished. Large-area surface elements having such fluorescent or phosphorescent substances thus bring about large-area illumination of the interior of the vehicle. Particular optical effects can be achieved with a suitable arrangement of the surface elements having the fluorescent or phosphorescent substances next to surface elements that do not contain such fluorescent or phosphorescent substances or that contain other fluorescent or phosphorescent substances which effect emission of visible light in another color or at a different time.

Correspondingly, in a method for producing an illumination device for the interior of a vehicle, in particular for producing the illumination device in accordance with the invention, wherein the illumination device has at least one radiation source, which can emit radiation, and has at least one surface element from which, as a reaction to radiation that was emitted by the radiation source and arrives at the surface element, visible light emerges, provision is made in accordance with the invention for the radiation source provided to be a source for ultraviolet radiation and for the surface element to be provided with fluorescent substances or with phosphorescent substances or to be provided with fluorescent substances and phosphorescent substances, wherein visible light emerges from the respective substances as a reaction to an excitation by ultraviolet radiation.

In a method for illuminating the interior of a vehicle, wherein a radiation source emits radiation, wherein radiation emitted by the radiation source arrives at a surface element and wherein visible light emerges from the surface element as a reaction to the radiation that arrives at the surface element, provision is made according to the invention for the radiation source to emit ultraviolet radiation, for the ultraviolet radiation to excite fluorescent substances in the surface element or phosphorescent substances in the surface element or to excite fluorescent substances and phosphorescent substances in the surface element, and for the visible light to emerge from the respective substances as a reaction to an excitation. The starting material is provided with the respective substances in particular over its entire surface area. Correspondingly, the surface element has the respective substances over its entire surface area. The radiation source for ultraviolet radiation is either a light bulb which can emit ultraviolet radiation, a light-emitting diode which can emit ultraviolet radiation, or another light source for ultraviolet radiation. The surface element is any desired part from the interior of a vehicle, in particular a textile part or a part made of plastic. The surface element is preferably at least one element from the group consisting of decorative material, door liner, roof liner, carpet, headrest and armrest.

The surface element has been treated in particular with an optical brightener or is made from a starting material which has been treated with an optical brightener. According to the method, for producing the illumination device, in particular the surface element is treated with an optical brightener or a starting material is treated with an optical brightener and the surface element is produced from this starting material. The starting material is preferably treated with the optical brightener over its entire surface area or the surface element is made from the starting material, which has been treated with the optical brightener, over its entire surface area. The surface element is then treated over its entire surface area with the optical brightener or is produced from the starting material that has been treated with the optical brightener. The optical brightener can be introduced into the surface element or into the starting material in various ways. The optical brightener is preferably introduced into the surface element or into the starting material using a method from the group consisting of printing, ink printing, foulard, spraying. The starting material here is in particular a yarn. The surface element is preferably a knit, a woven fabric or a warp-knit. Alternatively, the surface element is a plastic part, for example.

According to a preferred embodiment of the method, the starting material, especially after it was treated with the optical brightener, is dyed at least in partial regions in a layer above the optical brightener. In a corresponding advantageous embodiment of the illumination device, the surface element is dyed at least in partial regions in a layer above the optical brightener. In this way, dyes are introduced into the surface element. To achieve particular optical effects, provision is particularly preferably made for the fluorescent substances or the phosphorescent substances to exhibit their fluorescent effect or phosphorescent effect only in partial regions of the surface element. To this end, the surface element has at least one central region, in which the surface element, in particular in the layer above the optical brightener, has not been dyed or has been dyed only in pale colors. According to the method, the starting material is correspondingly not dyed, or dyed only in pale colors, in at least one central region, in particular in the layer above the optical brightener. In this way, ultraviolet light can reach the fluorescent substances or the phosphorescent substances, with the result that visible light either can be emitted directly or backlights the pale colors.

The surface element furthermore preferably has at least one peripheral region, in which the surface element is dyed a dark color, in particular in the layer above the optical brightener. The peripheral region that has been dyed a dark color covers the fluorescent substances or the phosphorescent substances located therebelow to an extent such that no visible light emerges from said respective substances or visible light emerging from said respective substances is at least largely blocked. According to the method, the surface element is correspondingly dyed a dark color in at least one peripheral region.

In an illumination device for the interior of a vehicle, in particular in the illumination device according to the invention, wherein the illumination device has at least one radiation source, which can emit radiation, and has at least one surface element from which, as a reaction to radiation that was emitted by the radiation source and arrives at the surface element, visible light emerges, provision is made in accordance with a further aspect of the invention for this illumination device to be used to provide at least one safety light. In this way it is possible for example for specific control elements to be optically highlighted in specific situations and thus to be easier to find. A closed or open door can also thus be illuminated over a large area on the inside, as a result of which it can be made visible in the dark.

Further embodiments are apparent from the drawing and from the following description of an exemplary embodiment of the invention which is schematically shown in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing an illumination device according to the invention.

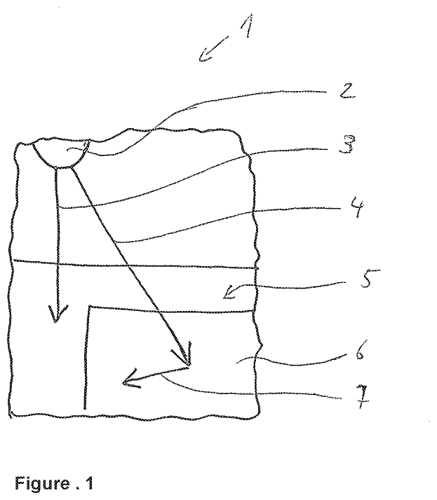

### DESCRIPTION OF PREFERRED EMBODIMENTS

Referring to the drawings, an illumination device according to the invention, designated with the reference sign 1. The illumination device 1 has a radiation source 2 for emitting ultraviolet radiation. The ultraviolet radiation emerging from the radiation source 2 is indicated and illustrated by two arrows 3 and 4. The ultraviolet radiation is incident on an interior part 5 of a vehicle. The surface of the interior part 5 is partially made up by a surface element 6. The surface element 6 is provided with an optical brightener having fluorescent substances, such that visible light emerges from the surface element 6 in reaction to the incoming ultraviolet radiation. Alternatively or additionally to the fluorescent substances, phosphorescent substances may be used if visible light is intended to continue to emerge from the surface element 6 after the radiation source 2 for ultraviolet radiation has been extinguished. The visible light is illustrated by an arrow 7. The ultraviolet radiation that is incident, according to arrow 3, on the interior part 5 outside the surface element 6, on the other hand, does not cause emission of visible light. The surface element 6 therefore has a non-illuminated effect outside the interior part 5. In this way, interesting optical effects can be produced or safety lights can be created.

All features mentioned in the above description are combinable in any desired selection. The disclosure of the invention is therefore not limited to the feature combinations described, claimed or shown in the drawing; rather, all feature combinations that are useful in the context of the invention should be considered to be disclosed.

While specific embodiments of the invention have been shown and described in detail to illustrate the application of the principles of the invention, it will be understood that the invention may be embodied otherwise without departing from such principles.

1. An illumination device for the interior of a vehicle, the illumination device comprising:
at least one radiation source configured to emit radiation; and
at least one surface element from which, as a reaction to radiation that was emitted by the radiation source and arrives at the surface element, visible light emerges, wherein the radiation source is a source for ultraviolet radiation and the surface element has fluorescent substances or phosphorescent substances or has fluorescent substances and phosphorescent substances, wherein the visible light emerges from the respective substances as a reaction to an excitation by the ultraviolet radiation.

2. The illumination device as claimed in claim 1, wherein the radiation source for ultraviolet radiation is a light bulb or a light-emitting diode.

3. The illumination device as claimed in claim 1, wherein the surface element is at least one element from the group: decorative material, door liner, roof liner, carpet, headrest and armrest.

4. The illumination device as claimed in claim 1, wherein the surface element has been treated with an optical brightener or is made from a starting material that has been treated with an optical brightener.

5. The illumination device as claimed in claim 4, wherein the starting material is a yarn.

6. The illumination device as claimed in claim 4, wherein the surface element is dyed at least in partial regions in a layer above the optical brightener.

7. The illumination device as claimed in claim 6, wherein the surface element has at least one central region, in which the surface element has not been dyed or has been dyed only in at least one of pale colors, and in that the surface element has at least one peripheral region in which the surface element is dyed a dark color, and the dark color is darker than the at least one central region dyed in the at least one of the pale colors.

8. The illumination device as claimed in claim 1, wherein the surface element is a knit, a woven fabric or a warp-knit.

9. A method for producing an illumination device for the interior of a vehicle, the method comprising the steps of:
providing the illumination device with at least one radiation source, which emits radiation, and at least one surface element from which, as a reaction to radiation that was emitted by the radiation source and arrives at the surface element, visible light emerges;
providing the radiation source as a source for ultraviolet radiation; and
providing the surface element with fluorescent substances or with phosphorescent substances or with fluorescent substances and phosphorescent substances, wherein visible light emerges from the respective substances as a reaction to an excitation of the fluorescent substances or the phosphorescent substances or the fluorescent substances and phosphorescent substances by ultraviolet radiation.

10. The method as claimed in claim 9, further comprising treating the surface element with an optical brightener or treating a starting material with an optical brightener and making the surface element from said starting material.

11. The method as claimed in claim 10, wherein the optical brightener is introduced into the surface element or into the starting material using a method from the group: printing, ink printing, foulard, spraying.

12. The method as claimed in claim 10, further comprising dying the surface element at least in partial regions in a layer above the optical brightener.

13. The method as claimed in claim 12, wherein the starting material is dyed only in at least one of pale colors in at least one central region of the surface element and in that the starting material is dyed a dark color in at least one peripheral region of the surface element, and the dark color is darker than the at least one central region dyed in the at least one of pale colors.

14. A method for illuminating the interior of a vehicle, the method comprising the steps of:
providing an illumination device in the interior of the vehicle, the illumination device comprising at least one radiation source and at least one surface element from which, as a reaction to radiation that was emitted by the radiation source and arrives at the surface element, visible light emerges;
emitting radiation with the radiation source, wherein radiation, which was emitted by the radiation source, arrives at a surface element, and wherein visible light emerges from the surface element as a reaction to the radiation that arrives at the surface element, wherein the radiation source emits ultraviolet radiation, and the ultraviolet radiation excites fluorescent substances in the surface element, and in that the visible light emerges from the fluorescent substances as a reaction to the excitation.

15. The method according to claim 14, the reaction to radiation that was emitted by the radiation source and that arrives at the surface element provides the visible light that emerges, for providing at least one safety light.
